(19) United States
(12) Patent Application Publication
(10) Pub. No.: US 2008/0314313 A1
(43) Pub. Date: Dec. 25, 2008

(54) Canister with a Resilient Flexible Chamber for Electrostatic Applicators

(76) Inventors: Ghaffar Kazkaz, Rolling Meadows, IL (US); John P. Wojcik, South Barrington, IL (US); James P. Baltz, Waterville, OH (US); David M. Seitz, Riga, MI (US); Roger T. Cedoz, Curtice, OH (US)

Correspondence Address: TAYLOR & AUST, P.C., P.O. Box 560, 142. S Main Street, Avilla, IN, 46710, US

(21) Appl. No.: 11/911,306

(22) PCT Filed: Apr. 12, 2006
(86) PCT No.: PCT/US2006/013925

§ 371 Date: Oct. 11, 2007

Related U.S. Application Data
(60) Provisional application No. 60/670,788, filed on Apr. 13, 2005.
(60) Provisional application No. 60/670,920, filed on Apr. 13, 2005.

(51) Int. Cl. B05C 5/00

(52) U.S. Cl. 118/300

(57) ABSTRACT

A canister for a coating applicator system has a flexible barrier separating a coating-containing region in the canister from a region containing a force applicator for moving the barrier to dispense the coating. While the volumes of each region change upon movement of the barrier, surfaces defining the regions remain in that region.

### TECHNICAL FIELD

The present invention relates generally to coating applicators and, more particularly, the present invention relates to electrostatic applicators adapted for the application of a variety of different coatings in rapid succession.

### BACKGROUND ART

Automatic spray applicators have wide ranging use for applying coatings of various types on objects during manufacture. For example, parts for automobile vehicle bodies commonly are coated using robotic devices with spray applicators. The robot is programmed to perform a sequence of maneuvers so that the vehicle body pieces are adequately and precisely covered in a rapid procedure with minimal waste of coating.

Atomizing applicators have been used to reduce the amount of overspray and further reduce waste. In a known atomizing applicator, a bell cup rotates at high speed, and the coating material, such as paint, is provided to the inside of the bell cup. As the paint or other coating moves outwardly and off the bell cup surface as a result of centrifugal force, the coating is atomized into a fine mist and directed at the object to be coated. It is known to direct air streams along the outside of the cup to confine and direct the atomized coating toward the object being coated. It is also known to charge the atomized mist with electrical potential and to ground the object being coated so that the coating material is attracted to the object, further reducing overspray and improving coverage on irregularly shaped target objects.

In present day manufacturing procedures, such as for automobile vehicle bodies, it is known to have parts in random color sequence advancing along the manufacturing line. Thus, for each object to be coated it may be necessary to change the color of paint or the type of coating used from that used for the previous object. Thirty or more different colors may be available to consumers purchasing automobiles, and at any point in the manufacturing process any of the colors may be necessary for coating the object that is placed before the robot. It is desirable that the time required for changing from one coating to another coating is kept short, so that the painting robot performance does not become a significant limiting factor in the manufacturing speed on the assembly line. In an advantageous system, the time required for changing the coating should be no longer than the time necessary to move a completed object from in front of the robot and to move the next target object into position for coating.

It has been proposed to use applicators with a series of interchangeable containers holding coatings of different types, such as paint of different colors. Between coating applications, the applicator relinquishes an empty container and receives a filled container having the proper coating for the next object. A fluid tube extends from the container and is inserted through the applicator to near the bell cup for supplying coating to the interior of the bell cup for subsequent atomization. However, inserting and removing the tube together with the canister can be cumbersome, and positioning the tube can be somewhat random in a channel large enough for receiving the tube. Therefore, supply of a coating to the atomizing bell can be somewhat random and inconsistent. Also, if a particular coating is not used frequently, and a canister containing the coating remains for long periods without use, small amounts of coating remaining in the tube from the previous use can harden, potentially clogging the tube.

In another proposed system, containers are held in a bank of containers. Each container is filled with a different type of coating, and can be placed selectively in fluid flow communication with the applicator through a supply line, without being directly attached to or mounted on the applicator.

Proposed constructions for canisters may experience problems as coating is dispensed or when the canister is refilled with coating. In a proposed construction, the canister has a substantially rigid wall that slides within the canister, reducing the volume for coating as coating is dispensed and increasing the volume as coating is added to the canister. Difficulties can be encountered in maintaining a fluid-tight seal at the interface between the sliding wall and the fixed surface of the canister. Further, portions of the wall surface alternatively form part of the coating containing volume and part of the non-coating containing volume as the wall slides in the canister. A thin film of coating remains on the wall as the canister is emptied of coating. If the canister is filled with a coating of different type, the remaining film contaminates the new coating. If the wall is moved by a dielectric dosing fluid pumped into the canister, the coating film on the wall contaminates the dosing fluid, and after time changes the dielectric properties of the dosing fluid if the coating is conductive.

Various other structures having bladders or inserts have been used or proposed, with varying degrees of success. What is needed is a canister for an atomizing applicator, which can be disconnected and connected rapidly, filled quickly between applicating procedures, and which empties reliably.

### DISCLOSURE OF THE INVENTION

The present invention provides a variety of canister constructions in which a barrier separates a coating-containing region from a region containing a force applicator for moving the barrier to dispense the coating. While the volumes of each region change upon movement of the barrier, surfaces defining the regions remain in only the one region that they define.

In one aspect thereof, the present invention provides a canister for holding coating to be applied by a spray applicator. The canister has an outer fixed volume shell including an applicator docking structure. The docking structure includes a coating outlet and a dosing fluid inlet. A bladder in the shell defines an interior variable volume, and a dosing fluid volume is defined within the shell exteriorly of the bladder. The dosing fluid volume is in flow communication with the dosing fluid inlet. A siphon tube in the bladder has an outlet in fluid flow communication with the coating outlet and at least one opening between the bladder interior volume and the siphon tube.

In another aspect thereof, the present invention provides a canister for supplying coating to a coating applicator with a fixed volume shell having first and second ends including a dosing fluid inlet and a coating material outlet at one of the ends and a dosing fluid outlet and a coating material inlet at the other of the ends. A bladder in the shell is fixed in position relative to the shell at the first and second ends and defines an interior volume. A siphon tube in the bladder extends between and in fluid flow communication with the coating material inlet and the coating material outlet. At least one opening in the tube is in communication with the interior volume of the bladder.

In another aspect thereof, the present invention provides a coating material canister for a coating applicator with a shell and a bladder in the shell isolating a confined coating material volume and a confined dosing fluid volume in the shell. A coating material outlet and a dosing fluid inlet are provided on one end of the shell communicating with the coating material volume and the dosing fluid volume, respectively. A coating material inlet and a dosing fluid outlet on an opposite end of the shell are in communication with the coating material volume and the dosing fluid volume, respectively.

An advantage of the present invention is providing a canister with a bladder therein for receiving coating to be applied, the bladder being configured and adapted for evenly distributing a dosing fluid around the bladder as dosing fluid is pumped into the canister to compress the bladder and eject coating from the bladder.

Another advantage of the present invention is providing a canister for containing electrically conductive coatings and electrically isolating the coating.

A further advantage of the present invention is providing a coating material canister with a bladder that both empties and fills evenly and consistently, without forming isolated pockets that hold coating.

A yet further advantage of the present invention is providing a coating material canister that is attached to and detached from an applicator easily and efficiently.

A still further advantage of the present invention is providing a canister and applicator valve arrangement that seals each to eliminate exposed coating and reduce the possibility of clogs formed by dried coating.

Other features and advantages of the invention will become apparent to those skilled in the art upon review of the following detailed description and drawings in which like numerals are used to designate like features.

### BRIEF DESCRIPTION OF DRAWINGS

FIG. 1 is a perspective view of an atomizing applicator having a coating canister in accordance with the present invention; . FIG. 2 is a cross-sectional view of the applicator shown in FIG. 1, the cross section taken on line 2-2 of FIG. 1;

FIG. 3 is an enlarged perspective view of the coating canister shown in FIGS. 1 and 2;

FIG. 4 is a cross-sectional view of the canister shown in FIG. 3, the cross section taken along line 4-4 of FIG. 3;

FIG. 5 is a cross-sectional view of a modified form of coating canister in accordance with the present invention;

FIG. 6 is a cross-sectional view of yet another modified form of canister in accordance with the present invention;

FIG. 7 is a cross-sectional view of another canister design in accordance with the present invention;

FIG. 8 is a schematic illustration of the operation of one embodiment for a bladder in accordance with the present invention;

FIG. 9 is a perspective view of yet another embodiment for a bladder in accordance with the present invention;

FIG. 10 is a cross-sectional view of the bladder shown in FIG. 9;

FIG. 11 is a cross-sectional view of another embodiment of the present invention;

FIG. 12 is a cross-sectional view of a further embodiment of the present invention; and

FIG. 13 is a view of still another embodiment of the present invention.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### BEST MODE FOR CARRYING OUT THE INVENTION

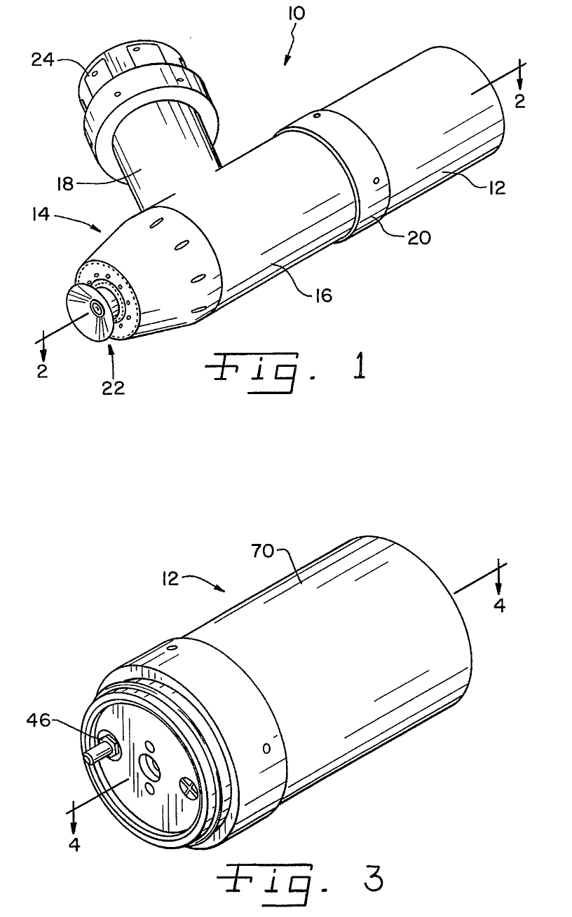

Referring now more specifically to the drawings and to FIG. 1 in particular, a rotary atomizing coating applicator assembly 10 is shown.

Applicator assembly 10 includes a canister 12 in accordance with the present invention operatively connected to an applicator 14 adapted for use with canister 12. Those skilled in the art will understand readily that applicator 10 is mounted on and operated by a robot (not shown) for performing a controlled series of maneuvers to properly and consistently coat a series of objects in a manufacturing process. For example, such applicators are used to paint automobile body parts. However, applicators of this type also can be used for coating a variety of different objects with paint and other coatings. It should be further understood that the present invention works well with different styles and types of applicators, and the precise configuration of applicator assembly 10 shown and described herein is merely one example of a suitable device for which canister 12 can be used.

Applicator 14 includes a main body 16 and a connector arm 18. A canister docking fixture 20 is provided at one end of main body 16, and a rotary atomizing head 22 is provided at the end of main body 16 opposite from docking fixture 20.

With reference now to the cross sectional view of FIG. 2, internal structures of applicator 14 will be described in greater detail. Connector arm 18 includes a robot adapter 24 that provides the structures by which applicator assembly 10 is connected to a robot (not shown). Robot adapter 24 physically connects applicator assembly 10 to the robot and has connections to various pneumatic, electric and fluid supply systems of the robot and painting station.

Within connector arm 18, a high voltage cascade 26 is provided for charging atomized coating particles in a manner well-known to those skilled in the art.

Atomizing head 22 includes a shroud 28 covering a forward end of main body 16 and an air turbine 30 provided in body 16. A rotary atomizing bell cup 32 is operatively connected to air turbine 30 for rotation thereby and the resultant atomization of coating materials supplied thereto in a manner well-known to those skilled in the art. Air turbine 30 receives a supply of pressurized air through a pressurized air line 34 communicating with an air connector in robot adaptor 24 and supplied with pressurized air from the robot and painting station (not shown). Additional pressurized air lines (not shown) are provided to various outlets in shroud 28 to provide shaping air to control and refine the pattern of atomized coating material from atomizing bell cup 32.

As thus far described, the components in main body 16 and connector arm 18 are known to those familiar with the art and therefore will not be described in further detail herein.

Robot adaptor 24 further includes a dosing fluid connector 40 by which applicator assembly 10 can be connected in flow communication with a source of dosing fluid, which preferably is a dielectric dosing fluid such as butyl acetate or other nonconductive fluid. A dosing fluid line 42 in connector arm 18 is in fluid flow communication with connector 40 and with a dosing fluid line 44 in main body 16. A dosing fluid shut-off valve assembly 46 is provided at the interface of canister 12 with main body 16 at canister docking fixture 20. Dosing fluid shut-off valve assembly 46 includes a shut-off valve 48 in main body 16 and a shut-off valve 50 in canister 12.

Main body 16 further includes a coating material supply tube 52 extending from canister docking fixture 20 to atomizing head 22 by which coating material is supplied from canister 12 to atomizing bell cup 32. A coating material shut-off valve assembly 54 is provided at the end of supply tube 52 generally in canister docking fixture 20, at the interface of canister 12 and main body 16. Coating material shut-off valve assembly 54 includes a shut-off valve 56 in main body 16 and an adjacent shut-off valve 58 in canister 12.

Dosing fluid shut-off valve assembly 46 and coating material shut-off valve assembly 54 provide cooperative shut-off valves 48, 50 and 56, 58, respectively, so that canister 12 can be undocked and removed from main body 16 without waste of dosing fluid or coating material flowing therebetween. Valve assemblies 46 and 54 are so called “quick connect” assemblies known for use in hydraulic systems, which include adjacent components that close when disconnected and mutually open upon connection to enable fluid flow therethrough. Thus, when canister 12 is connected to applicator 14 shut-off valves 48 and 50 in dosing fluid shut-off valve assembly 46 are mutually enabling and immediately adjacent each other to provide dosing fluid flow therethrough. Shut-off valves 56 and 58 are mutually enabling and immediately adjacent each other in coating material shut-off valve assembly 54 to provide coating material flow therethrough. Upon disconnect of canister 12 from applicator 14, each valve 48, 50, 56 and 58 closes and prevents flow of dosing fluid or coating material therethrough.

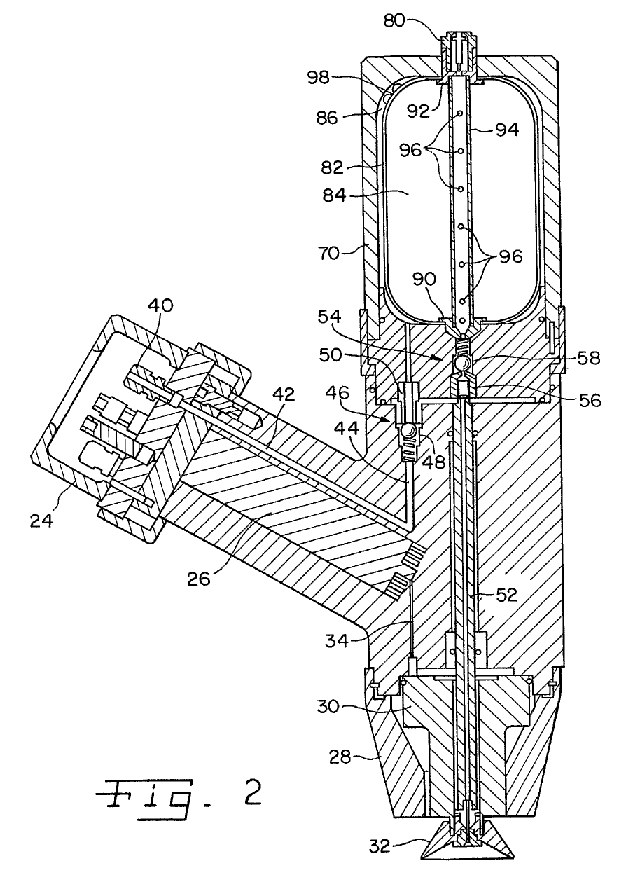

With reference now particularly to the enlarged cross sectional view of FIG. 4, canister 12 will be described in greater detail. Canister 12 includes a substantially rigid outer shell 70 having a first end 72 and an opposed second end 74. First end 72 defines an applicator docking structure by which canister 12 is connected to main body 16 at docking fixture 20. Vacuum is applied in a vacuum chamber 76 defined in first end 72, sealed by an o-ring 78 against main body 16. Vacuum is drawn in vacuum chamber 76 after canister 12 is placed against main body 16 and vacuum is maintained so long as canister 12 is to be connected to main body 16. Docking rings, clamps and pins also are suitable for securing canister 12 to main body 16, and may be preferred for electrostatic application systems to avoid arcing through the vacuum environment that can occur at lower voltage and across greater distances than in an environment at atmospheric pressure.

First end 72 further includes shut-off valve 50 of dosing fluid shut-off valve assembly 46 and coating material shut-off valve 58 of coating material shut-off valve assembly 54.

Second end 74 defines a refill station docking structure including a coating material inlet valve assembly 80. Canister 12 is connectable to a refill station docking structure (not shown) for the purpose of supplying coating material to canister 12.

Shell 70 with first and second ends 72 and 74, respectively, defines a fixed volume interior of canister 12. A bladder 82 is disposed therein, with bladder 82 defining a bladder interior volume 84. Interior volume 84 is variable, upon addition or expulsion of coating material from bladder 82. Thus, between bladder 82 and shell 70, a variable actuator or dosing fluid volume 86 is defined, which is in flow communication with a dosing fluid passage 88 from dosing fluid shut-off valve 50.

Bladder 82 extends between first and second ends 72 and 74, secured thereto by an outlet flange 90 at first end 72 and an inlet flange 92 at second end 74. Outlet flange 90 and inlet flange 92 define an outlet and an inlet, respectively to interior volume 84 of bladder 82 through first and second ends 72 and 74, respectively. Flanges 90 and 92 are sealed to openings in bladder 82 so as to isolate interior volume 84 within bladder 82 from dosing fluid volume 86 exteriorly of bladder 82. Thus, coating material within bladder 82 flows from bladder 82 through outlet flange 90 and coating material supplied to bladder 82 flows into interior volume 84 through inlet flange 92, and is isolated from dosing fluid in dosing fluid volume 86.

Bladder 82 can be constructed of various materials, including elastic materials, non-elastic materials and semi-elastic materials, depending on the type of coating material to be dispensed therefrom. In selecting an appropriate material, consideration is given to compatibility with constituents of coating materials to be dispensed, solvents for the coating material and the dosing fluid, in addition to expansion and contraction characteristics of the bladder, fold formations and the like that may cause fatigue cracks, and the like. EPDM is a suitable material for use with water based paints or other coating material having low solvents concentration.

A siphon tube 94 is provided within bladder 82. Siphon tube 94 extends from and between first end 72 and second end 74 and is flow communication with inlet flange 92 and outlet flange 90. Thus, siphon tube 94 can be placed in fluid flow communication with a coating material supply at a refill structure (not shown) whereat coating material is supplied to bladder 82. Siphon tube 92 also can be placed in fluid flow communication with coating material supply tube 52 of main body 16 via coating material shut-off valve assembly 54 when canister 12 is docked with main body 16. Siphon tube 94 is substantially rigid, defining fixed positions for bladder 82 at outlet flange 90 and inlet flange 92. Thus, as bladder 82 expands or contracts, any movement thereof is primarily radial in direction, and only insignificantly, if at all, in the longitudinal direction.

Controlling the expansion and contraction of bladder 82 in this manner reduces the possibility that pockets or constrictions will be formed as bladder 82 expands or contracts.

Siphon tube 94 includes at least one and preferably several openings 96 along the length thereof between outlet flange 90 and inlet flange 92. Openings 96 provide fluid flow communication between the interior of siphon tube 94 and interior volume 84 of bladder 82. Thus, coating material supplied to siphon tube 94 through inlet flange 92 flows into interior volume 84 through openings 96.

Further, coating material flowing from interior volume 84 of bladder 82 enters siphon tube 94 through openings 96 and can thereafter flow through coating material shut-off valve assembly 54 to coating material supply tube 52 and atomizing bell cup 32.

To expel coating material from bladder 82, dosing fluid is pumped into dosing fluid volume 86. As dosing fluid is added to dosing fluid volume 86, bladder 82 is compressed, expelling coating material through siphon tube 94 as described previously. Advantageously, the dosing fluid is a dielectric fluid.

To encourage an even flow of dosing fluid around bladder 82, an exterior surface thereof defines channels 98 to promote an even flow of dosing fluid through dosing fluid volume 86. Channels 98 can be formed as depressions in the surface of bladder 82 or can be defined between ridges on the exterior surface of bladder 82. The channels can be longitudinally oriented, angularly oriented or otherwise positioned on the surface of bladder 82. Promoting an even flow of dosing fluid around and along bladder 82 provides equal pressure along and around bladder 82, and further aids in eliminating the formation of pockets and constrictions. Further however, bladder 82 can be constructed in different geometries to promote even and consistent flow of dosing fluid therearound.

FIG. 5 illustrates a bladder 100 that is formed in a shape to include longitudinal lobes 102, 104 and 106. Each lobe 102, 104, 106 is substantially, permanently fixed adjacent shell 70 and may be physically attached thereto by adhesive or the like. Alternatively, bladder 100 can be formed with sufficient rigidity to maintain the shape shown in FIG. 5 when bladder 100 is empty. Siphon tube 92 extends centrally through bladder 100 to function as described previously herein. Movable bladder walls 108, 110 and 112 are provided between, respectively, lobe 102 and lobe 104; lobe 104 and lobe 106 and between lobe 106 and lobe 102. Bladder walls 108, 110 and 112 are flexible and moveable between a collapsed position as illustrated in FIG. 5 when bladder 100 is substantially empty and an expanded position (not shown) when bladder 100 is substantially full. In the expanded position, bladder walls 108, 110 and 112 are moved away from siphon tube 94 and are substantially near and adjacent shell 70. Thus, as dosing fluid is supplied to dosing fluid volume 86, bladder walls 108, 110 and 112 collapse, promoting even flow and distribution of dosing fluid within dosing fluid volume 86. It should be understood that more lobes or fewer lobes than the three lobes illustrated can be used, including two lobes in a substantially flat bladder when empty.

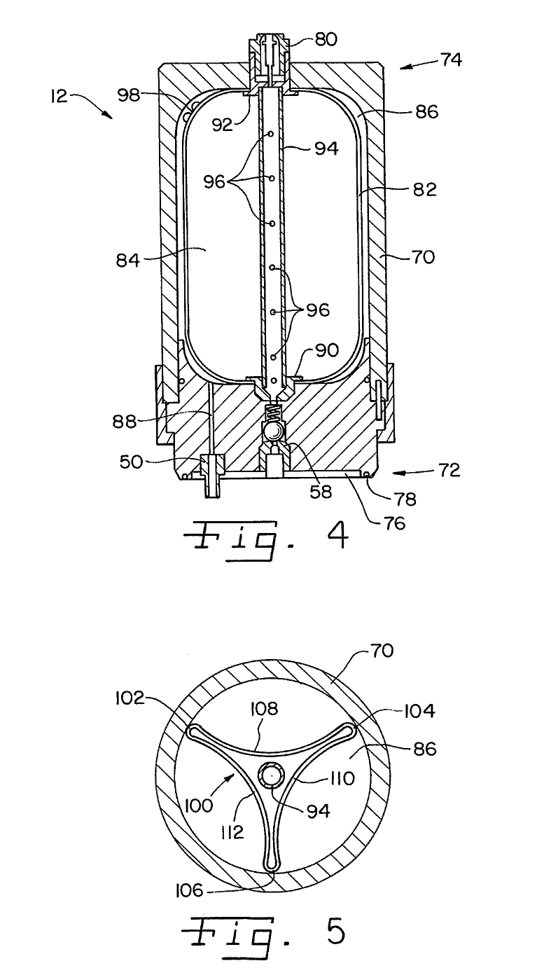

FIG. 6 illustrates yet another embodiment of the present invention. A further modified bladder 120 is shown, which has a first end 122 and a second end 124. First end 122 is nearest the inflow of dosing fluid from dosing fluid passage 88 and is smaller in diameter than is second end 124 of bladder 120. Thus, with the diminishing area extending away from the inlet of dosing fluid, dosing fluid flows evenly and smoothly around bladder 120 as bladder 120 is compressed to eject coating material through siphon tube 94.

FIG. 7 illustrates yet another canister assembly 200 having an outer body 202 and a collapsible bladder 204 therein. Canister assembly 200 is configured with a connecting end 206 through which coating material is filled into bladder 204 and from which coating material in bladder 204 is dispensed to an applicator. Accordingly, connecting end 206 includes a coating material conduit 208 with appropriate valve structures 210 for admitting coating to bladder 204 and for dispensing coating from bladder 204. A dosing fluid line 212 communicates with a space between bladder 204 and the interior wall surface of outer body 202.

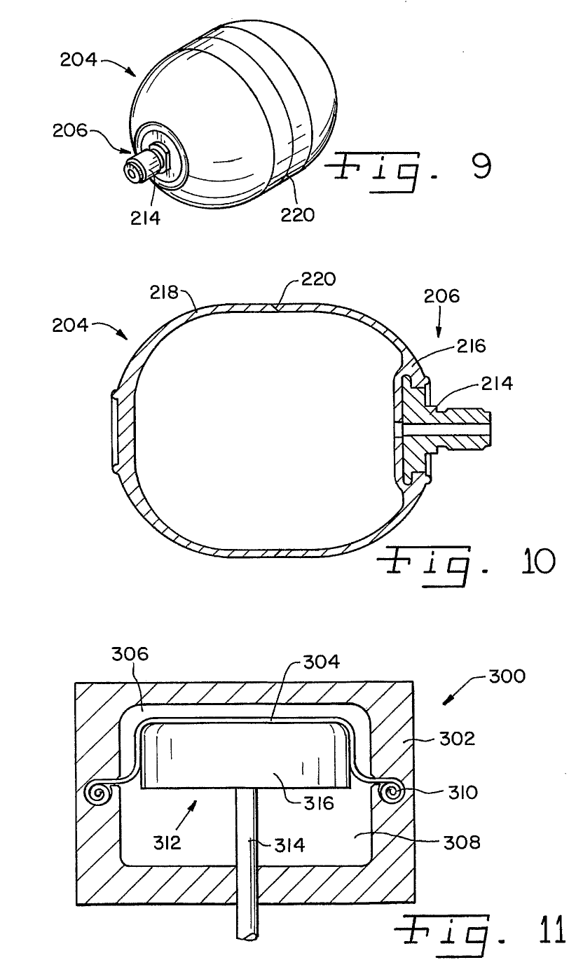

Bladder 204 is generally bulbous in shape and may be spherical. A generally oblate spheroid bladder 204 is shown in FIGS. 9 and 10. As seen most clearly in FIG. 10, a valve stem assembly 214 of substantially rigid material is affixed to a receiving end 216 of a substantially flexible bladder body 218.

Bladder body 218 can be formed in a variety of different molding or forming techniques and may be formed as a single body or from two separate bladder body pieces joined along a circumferential seam 220 by welding or other fastening techniques.

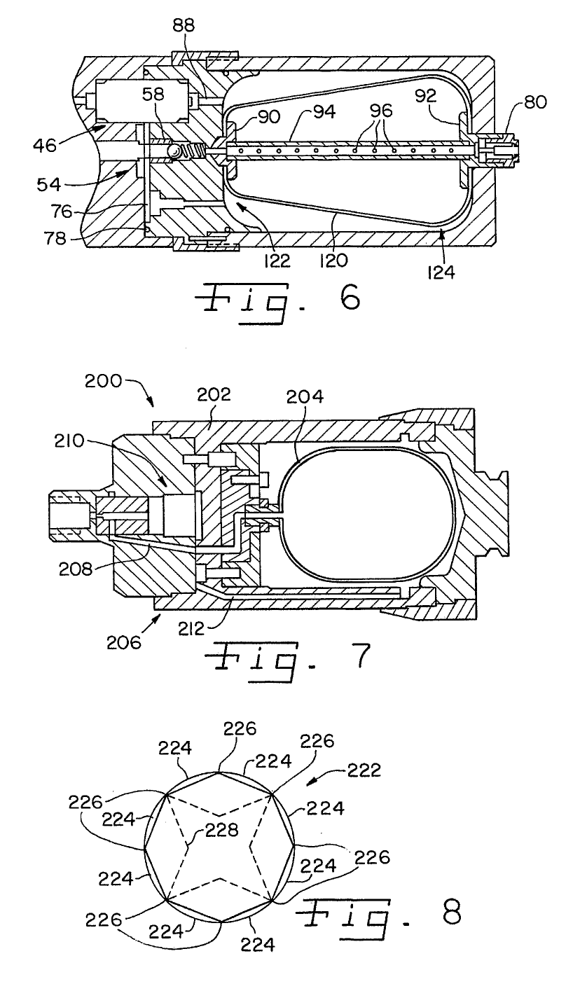

Bladder body 218 is substantially flexible and collapsible, and may be configured with more rigid and less rigid patterns to promote efficient collapse of bladder body 218 during the discharge of coating from the interior thereof. FIG. 8 illustrates a structure in which a bladder body 222 has alternating thicker regions 224 at which the bladder has a lesser tendency to bend and thinner regions 226 having greater tendency to bend such that bladder body 222 collapses in a star-shaped pattern as viewed in diametric cross-section. FIG. 8 illustrates the collapsing pattern as dashed lines 228.

In some applications and uses of the invention it may be advantageous to affix portions of the various bladder bodies to interior surfaces of the shells containing them such that a preferred collapsing pattern is promoted in the bladder body. Further, bladders not having internal siphon tubes can be used, or siphon tubes can be associated with any of the bladders described herein.

The canisters of the exemplary embodiments described thus far have been configured with the coating materials, such as paint, contained within the bladder, and the space outside of the bladder configured to receive dosing fluid to compress the bladder and expel the paint. However, it should be understood that the canister configuration with the applicator can be such that paint or other coating material is supplied to and expelled from the space exteriorly of the bladder, between the bladder and the canister wall. In such configurations, dosing fluid is pumped into the bladder to expand the bladder and expel paint from the space outside of the bladder.

While shown and described for use as interchangeable installations in which the canisters are placed directly on and removed from an applicator, canisters in accordance with the present invention also can be used in more or less fixed installations. Multiple canisters can be provided in a manifold arrangement, with one or more canister for each different type of coating used. The canisters remain fixed with respect to each other, although the canisters may be on a moveable structure, such as a robot base. Alternatively, the canisters can be in a fixed position within a paint booth. Yet further, the canisters can be arranged in multiple groups. In such fixed installations valves and conduits are used to selectively establish the full canisters in fluid flow communication with the applicator, and to connect empty canisters in fluid flow communication with coating supply sources for filling, while the canisters remain at an installed location. An entire group of canisters can be charged electrically along with the applicator, while being isolated electrically from the coating supply source by the long length of tube to the source and appropriate electrical isolation valves, as needed.

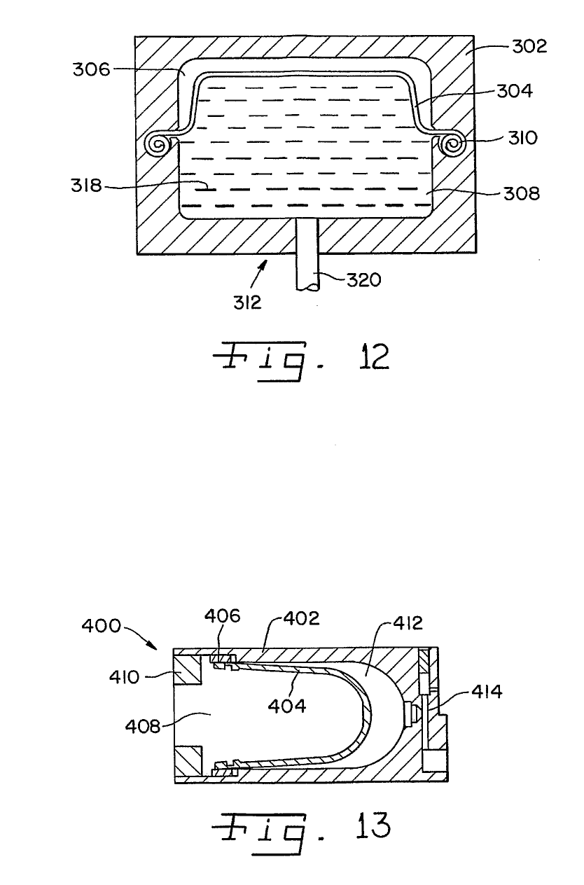

FIG. 11 illustrates yet another canister 300 of the present invention in which an outer body 302 defines an enclosed inner volume separated by a barrier such as a diaphragm 304 into a coating material space 306 and an actuator space 308. Diaphragm 304 can be a rolling sheet having a take-up and dispensing supply 310, or diaphragm 304 can be an elastic, stretchable material fixed about its periphery to body 302. An actuator 312 is configured to move diaphragm 304, decreasing the volume of coating material space 306 for dispensing coating therefrom. Actuator 312 can be a mechanical type actuator having an actuator arm 314 and a head 316. In another embodiment of the invention, actuator 312 can be dosing fluid 318 (FIG. 12) pumped into actuating space 308, via a dosing fluid supply 320, with dosing fluid 318 operating directly against barrier diaphragm 304. In still another variation, actuator 312 can be a combination of a dosing fluid and a mechanical form moved thereby. Diaphragm 304 is moved to closely follow the contour of the outer wall defining coating material space 306. When a mechanical actuator is used, actuator head 316 can be shaped much as the interior wall surface of coating material space 306. As with other embodiments disclosed herein, all inner surfaces of outer body 302 remain either in coating material space 306 or actuating space 308, and coating material within coating material space 306 cannot contaminate actuating space 308, being effectively sealed therefrom by diaphragm 304. Even as the volumes change for coating material space 306 and actuating space 308, the surfaces defining the volumes remain within only the one volume. Further, when coating material space 306 is cleaned all surfaces that contact coating are exposed for cleaning.

FIG. 13 illustrates yet another embodiment of the present invention. Canister 400 includes an outer shell 402 and a variable barrier 404 therein. In this exemplary embodiment, variable barrier 404 is a flexible pouch 404 disposed within shell 402. Pouch 404 is open at an end 406, which is sealed to outer shell 402. Dosing fluid is supplied to a dosing fluid space 408 within pouch 404 and the space between pouch 404 and a cover 410 of canister 400. A coating material space 412 is proved within shell 402 exteriorly of pouch 404. A two-way valve assembly 414 establishes flow into and out of coating material space 412 from a coating material source and to an applicator.

Bladders, diaphragms and the like shown herein are made of material having the necessary flexibility for moving as described for the various embodiments while also being inert to dosing fluids used and/or the constituents of the coating material including solvents used for cleaning the coating material. EPDM and butyl rubbers provide the appropriate flexibility while being inert to commonly used coatings, dosing materials and solvents. However, other material also may be suitable. All such materials also should be non-conductive when used in electrostatic spray applicators. Further, EPDM, butyl rubbers and other materials that are generally appropriate may include various additives for improving strength, flexibility and overall longevity.

The present invention provides readily interchangeable or selectively connectable canisters for an applicator assembly such that each of the various canisters can be supplied with a different coating material, such as different colors of paint. To ensure that the proper coating material, such as the proper color paint is being used with each particular application, each canister can be provided with an RF tag by which the canister and therefore the coating material contained therein can be identified. The technology for RF tagging or flagging is well-known and will not be described in further detail herein.

To further provide smooth consistent expulsion of coating material from the bladder, the bladder can be formed of material having differing wall thickness to provide controlled collapse in a desirable configuration such that dosing fluid flows evenly around the bladder. Such controlled collapse of the bladder can be used either in place of, or in conjunction with the formation of channels or ribs on an outer surface of the bladder or any other of the configurations described previously herein to improve dosing fluid flow around the bladder and to reduce the formation of pockets or constrictions in the bladder.

Canisters of the present invention and the use of barriers therein are particularly useful for applications requiring voltage blocks when conductive coating materials, such as water based paints are used. The barrier and shell can be made of dielectric material and a dielectric fluid can be used as the dosing fluid to provide the appropriate voltage block around electrically conductive coating materials.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A canister for holding coating to be applied by a spray applicator, said canister comprising:
an outer fixed volume shell including an applicator docking structure, said docking structure including a coating outlet and a dosing fluid inlet;
a bladder in said shell defining an interior variable volume;
a dosing fluid volume defined within said shell exteriorly of said bladder, said dosing fluid volume being in flow communication with said dosing fluid inlet; and
a siphon tube in said bladder, said siphon tube having an outlet in fluid flow communication with said coating outlet and at least one opening between said bladder interior volume and said siphon tube.

2. The canister of claim 1, said siphon tube extending from one end of said bladder to an opposite end of said bladder.

3. The canister of claim 1, said bladder defining dosing fluid distributing channels in an exterior surface thereof.

4. The canister of claim 1, said shell having a refill station docking structure including a coating inlet in fluid flow communication with said bladder interior and a dosing fluid outlet in fluid flow communication with said dosing fluid volume.

5. The canister of claim 4, including fluid shut-off valves at said inlets and said outlets.

6. The canister of claim 4 having first and second ends, with said applicator docking structure at one of said ends and said refill docking structure at the other of said ends.

7. The canister of claim 6, said siphon tube extending between and in fluid flow communication with said coating inlet and said coating outlet.

8. The canister of claim 1, said bladder being elastic.

9. The canister of claim 1, said bladder being flexible and non-elastic.

10. The canister of claim 1, said bladder being semi-elastic.

11. The canister of claim 1, said bladder being substantially cylindrical.

12. The canister of claim 1, said bladder having a non-filled configuration defining at least two lobes in substantially fixed positions spaced from said siphon tube and having moveable wall segments between said lobes.

13. The canister of claim 1, said bladder having first and second ends of different diameters.

14. A canister for supplying coating to a coating applicator, said canister comprising:
a fixed volume shell having first and second ends including a dosing fluid inlet and a coating material outlet at one of said ends and a dosing fluid outlet and a coating material inlet at the other said ends;
a bladder in said shell fixed in position relative to said shell at said first and second ends, said bladder defining an interior volume;
a siphon tube in said bladder extending between and in fluid flow communication with said coating material inlet and said coating material outlet, and at least one opening in said tube in communication with said interior volume of said bladder.

15. The canister of claim 14, defining dosing fluid distributing channels in an exterior surface thereof.

16. The canister of claim 14, said bladder being substantially cylindrical.

17. The canister of claim 14, said bladder having a non-filled configuration defining at least two lobes in substantially fixed positions spaced from said siphon tube and having moveable wall segments between said lobes.

18. The canister of claim 14, said bladder having first and second ends of different diameters.

19. A coating material canister for a coating applicator, comprising:
a shell;
a bladder in said shell isolating a confined coating material volume and a confined dosing fluid volume in said shell;
a coating material outlet and a dosing fluid inlet on one end of said shell communicating with said coating material volume and said dosing fluid volume, respectively; and
a coating material inlet and a dosing fluid outlet on an opposite end of said shell communicating with said coating material volume and said dosing fluid volume, respectively.

20. The applicator assembly of claim 19, said canister having a first end and a second end, and said bladder being secured to said canister at said first and second ends.
